(19) United States
(12) Patent Application Publication
(10) Pub. No.: US 2021/0233370 A1
(43) Pub. Date: Jul. 29, 2021

(54) System and Method for Identifying Users

(71) Applicant: Everseen Limited, Blackpool (IE)

(72) Inventors: Razvan-Dorel Cioarga, Oradea (RO); Cristian-Cornel Cucuiet, Sacalaz (RO); Dan Cristian Chiciudean, Timisoara (RO)

(73) Assignee: Everseen Limited, Blackpool (IE)

(21) Appl. No.: 17/160,806

(22) Filed: Jan. 28, 2021

Related U.S. Application Data
(60) Provisional application No. 62/967,123, filed on Jan. 29, 2020.

(51) Int. Cl. G08B 13/19; G08B 13/196; G08B 21/22; H04N 5/33; H04N 7/18

(52) U.S. Cl. CPC G08B 13/19; G08B 13/19641; H04N 7/181; G08B 21/22; H04N 5/33; G08B 13/19654

(57) ABSTRACT

A system for identifying a type of a user in a warehousing environment includes a plurality of Infra Red (IR) Light Emitting Diode (LED) devices provided to users in the warehousing environment, a plurality of cameras, and a user identification unit. The user identification unit includes a memory to store one or more instructions, and a processor communicatively coupled to the memory, and configured to receive an image frame captured by the plurality of cameras, detect one or more IR LED devices in the image frame based on signals emitted by the one or more IR LED devices, detect an IR LED group of each detected IR LED device based on a geometric configuration, a blinking frequency, and a color of LEDs of corresponding IR LED device, and determine a type of user of each IR LED device based on detected LED group of corresponding IR LED device.

### CROSS REFERENCE TO RELATED APPLICATION(S)

This application claims priority to and the benefit of U.S. Provisional Patent Application No. 62/967,123, filed Jan. 29, 2020, the entire disclosure of which is hereby incorporated by reference.

### TECHNICAL FIELD

The present disclosure relates generally to a retail store environment, and more specifically to a method for automatic differentiation of customers versus associates in a retail store environment using an infrared (IR) light emitting diode (LED) badge holder reel device.

### BACKGROUND

Retail warehouses are large, single level stores, that normally sell goods for home improvement, or gardening, electrical goods, carpets and so on. A typical retail warehouse environment may include multiple store associates travelling in a monitored area for performing various warehousing activities such as receiving order, picking an order, packing an order, and shipping the order. Receiving refers to the acceptance and storage of incoming inventory at an order fulfillment center. When the fulfillment center receives the inventory, the items may be stored in dedicated warehousing locations. In the picking sub-process, the picking team receives a packing slip with the items, quantities, and storage locations at the facility to collect the ordered products from their respective pallets.

For security reasons, it may be important to distinguish between persons traveling in the monitored area in a retail warehouse environment, more precisely between customers and retail store associates. However, the technique of distinguishing between persons should be cost effective, and should not interfere with existing other kind of security control mechanisms based on magnetic badges, password codes, biometric recognition etc.

### SUMMARY

In an aspect of the present disclosure, there is provided a system for identifying a type of a user in a warehousing environment. The system includes a plurality of IR LED devices provided to a corresponding plurality of users in the warehousing environment, wherein each IR LED device includes a plurality of LEDs arranged in a predetermined geographical configuration, and configured to emit signals at a predetermined blinking frequency. The system further includes a plurality of cameras installed in the warehousing environment to capture one or more images pertaining to the IR LED devices of the warehousing environment. The system furthermore includes a user identification unit, in communication with the plurality of cameras. The user identification unti includes a memory to store one or more instructions, and a processor communicatively coupled to the memory, and configured to receive an image frame captured by the plurality of cameras, detect one or more IR LED devices in the image frame based on signals emitted by the one or more IR LED devices, detect an IR LED group of each detected IR LED device based on a geometric configuration, a blinking frequency, and a color of LEDs of corresponding IR LED device, and determine a type of user of each IR LED device based on detected LED group of corresponding IR LED device.

In another aspect of the present disclosure, there is provided a method for identifying a type of a user in a warehousing environment, in that each user is provided with an IR LED device. The method includes receiving an image frame captured by a plurality of cameras, detecting one or more IR LED devices in the image frame based on signals emitted by the one or more IR LED devices, detecting an IR LED group of each detected IR LED device based on a geometric configuration, a blinking frequency, and a color of LEDs of corresponding IR LED device, and determining a type of user of each IR LED device based on detected LED group of corresponding IR LED device.

In yet another aspect of the present disclosure, there is provided a computer programmable product for identifying a type of user in a warehousing environment. The computer programmable product includes a set of instructions, the set of instructions when executed by a processor causes the processor to receive an image frame captured by a plurality of cameras, detect one or more IR LED devices in the image frame based on signals emitted by the one or more IR LED devices, detect an IR LED group of each detected IR LED device based on a geometric configuration, a blinking frequency, and a color of LEDs of corresponding IR LED device, and determine a type of user of each IR LED device based on detected LED group of corresponding IR LED device.

Various embodiments of the present disclosure automatically differentiate a person entering a video monitored area based on an IR LED Badge Holder Reel device, using an existent video surveillance infrastructure. The disclosure may be useful for building various applications dedicated to improving customer services by reducing waiting time, asset protection by identifying customer access to restricted areas, and many other various associate processes. The discrimination is made automatically, and in a way transparent to the user. It does not imply any actions or special procedures. It does not interfere in any way with the normal retail flow and procedures. However, it supports corrective measures by alerting associates, associates supervisors or by taking some automatic measures.

Further embodiments of the present disclosure, describes a system and a method for identifying the kind of a person entering a video monitored area. More precisely, its main applicability is in differentiating between customers and associates in, but not limited to, a retail environment. It can be used as a main component of applications regarding customer services, access security, and various associate processes. The methodology is adaptable to other use case scenarios and is applicable in any environment in which a person carrying a badge is involved in a process developed in a video monitored area. The cost of the solution is significantly low compared with other existing solutions e.g. based on RFIDs as it uses pre-existent video surveillance infrastructure.

It will be appreciated that features of the present disclosure are susceptible to being combined in various combinations without departing from the scope of the present disclosure as defined by the appended claims.

### BRIEF DESCRIPTION OF THE DRAWINGS

The summary above, as well as the following detailed description of illustrative embodiments, is better understood when read in conjunction with the appended drawings. For the purpose of illustrating the present disclosure, exemplary constructions of the disclosure are shown in the drawings. However, the present disclosure is not limited to specific methods and instrumentalities disclosed herein. Moreover, those in the art will understand that the drawings are not to scale. Wherever possible, like elements have been indicated by identical numbers.

FIG. 1A is a block diagram of a system for identifying a type of user in a warehousing environment, in accordance with an embodiment of the present disclosure;

FIG. 1B illustrates a warehousing environment, wherein the system of FIG. 1A can be used;

FIG. 2 illustrates an exemplary IR LED badge holder reel device; and

FIG. 3 is a flowchart illustrating a method for identifying a type of a user in the warehousing environment, in accordance with an embodiment of the present disclosure.

In the accompanying drawings, an underlined number is employed to represent an item over which the underlined number is positioned or an item to which the underlined number is adjacent. A non-underlined number relates to an item identified by a line linking the non-underlined number to the item. When a number is non-underlined and accompanied by an associated arrow, the non-underlined number is used to identify a general item at which the arrow is pointing.

### DETAILED DESCRIPTION OF ILLUSTRATIVE EMBODIMENTS

The following detailed description illustrates embodiments of the present disclosure and ways in which they can be implemented. Although the best mode of carrying out the present disclosure has been disclosed, those skilled in the art would recognize that other embodiments for carrying out or practicing the present disclosure are also possible.

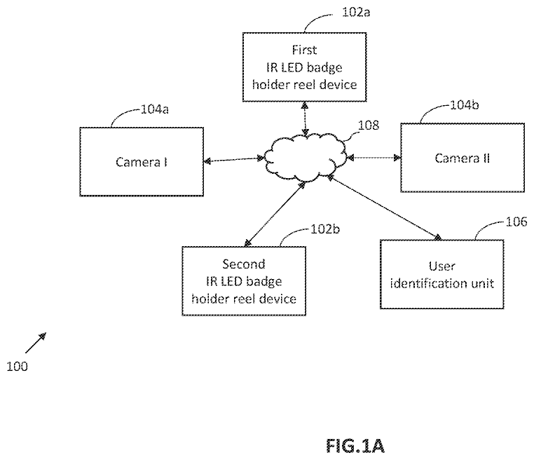

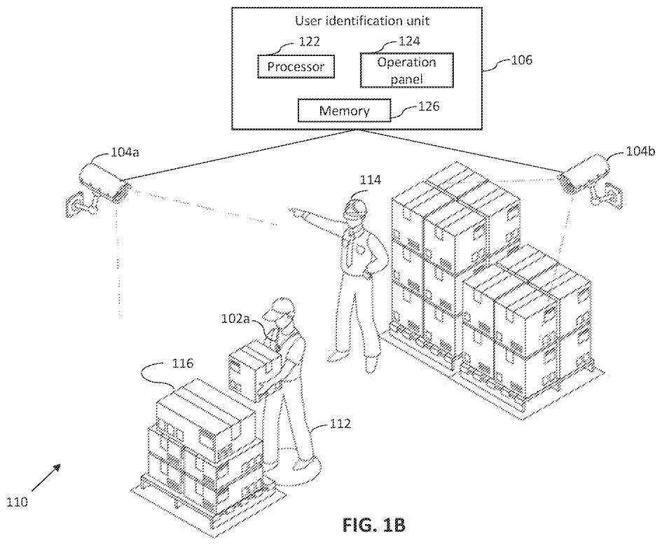

FIG. 1A is a block diagram of a system 100 for identifying a type of a user in a warehousing environment, in accordance with an embodiment of the present disclosure. The system 100 includes first and second Infra Red (IR) Light Emitting Diode (LED) badge holder reel devices 102a and 102b, first and second cameras 104a and 104c, and a user identification unit 106, each communicatively coupled to each other through a communication network 108. The communication network 108 may be any suitable wired network, wireless network, a combination of these or any other conventional network, without limiting the scope of the present disclosure. Few examples may include a Local Area Network (LAN), wireless LAN connection, an Internet connection, a point-to-point connection, or other network connection and combinations thereof. Although, two IR LED badge holder reel devices 102a and 102b, and two cameras 104a and 104c are being shown herein, it would be apparent to a person of ordinary skill in the art, that there may be more than two IR LED devices and two cameras in the system 100. The user identification unit 106 executes machine learning algorithms such as deep neural networks to identify type of users wearing the IR LED badge holder reel devices 102a and 102b based on the images of the IR LED badge holder reel devices 102a and 102b captured by the first and second cameras 104a and 104c.

FIG. 1B illustrates a warehousing environment 110, wherein the system 100 can be used. The warehousing environment 110 pertains to a warehouse that accepts and stores incoming inventory of various types of goods. It would be apparent to one of ordinary skill in the art that the system 100 is not limited to be used in the warehousing environment 100, and can be used in a retail store environment, an airport security area, and the like.

The warehousing environment 110 includes a store associate 112 managing one or more pallets 116 of goods, a customer 114, the first and second cameras 104a and 104b and a user identification unit 106 communicatively coupled to the first and second cameras 104a and 104b. The store associate 112 is shown to be wearing the first IR LED badge holder reel device 102a. It is to be noted, that the first and second cameras 104a and 104b are a part of an existing video monitoring system of the warehousing environment 110 to make the warehousing environment 110, a video monitored area. Examples of the first and second cameras 104a and 104b may include at least one of: a 360° camera, a Closed-Circuit Television (CCTV) camera, a High Definition (HD) camera, and a non-HD camera, or any analog and digital video camera that has a high sensitivity on Infrared (IR) spectrum and is able to detect IR LED emissions from the first and second IR LED badge holder reel devices 102a and 102b.

In the context of the present disclosure, the store associate 112, the customer 114, the first IR LED badge holder reel device 102a are covered by the field of views (FoVs) of the first and second cameras 104a and 104b. Each of the first and second cameras 104a and 104b has a FoV representing a three-dimensional (3D) cone in which environment objects may be perceived. Although, one person is shown to be wearing the IR LED badge holder reel device 102a in the environment 110, it would be apparent to one of ordinary skill in the art that the environment 110 may include a large number of personnel, each wearing the IR LED badge holder reel device.

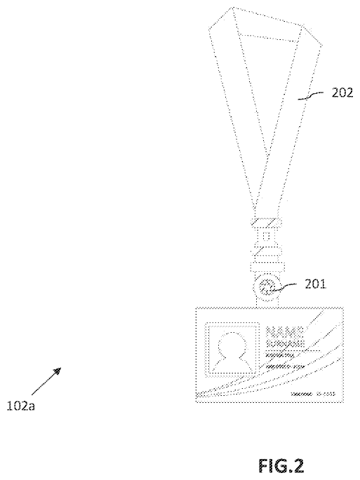

FIG. 2 illustrates the first IR LED badge holder reel device 102a in detail, in accordance with an embodiment of the present disclosure.

The first IR LED badge holder reel device 102a includes a battery powered electronic board with one or more IR LEDs (not shown) in a predetermined geometrical configuration behind an optical lens 201 on the reel. In an example, the IR LEDs may be powered by a 1.5 W battery. The predetermined geometrical configuration may be selected from one of: a line configuration, a square configuration, and a triangle configuration, etc. Further, the IR LEDs may be configured to blink at a predetermined blinking frequency. Also, the IR LEDs may be of a predefined color.

The IR LEDs of the device 102a are configured to emit light into multiple directions, and the optical lens 201 is configured to scatter the light emitted by corresponding IR LEDs to increase the detection angle. The detection angle represents the angle of FoVs of the first and second cameras 104a and 104b, where the device 102a is visible. To be visible to the first and second cameras 104a and 104b, the device 102a should be in the FoV of such cameras. In case of multiple cameras, the reunion of all FoVs defined the sensed volume. The IR LED badge holder reel device 102a may be installed in an existing badge holder 202 already carried by associates in most retail environments.

In an embodiment of the present disclosure, the IR LEDs of the device 102a may be controlled with a periodic step signal so that the IR LEDs have a corresponding blinking frequency. In another embodiment of the present disclosure, each IR LED badge holder reel device 102a may be configured to emit IR LED signals at a predetermined blinking frequency.

In the context of the present disclosure, each associate of the warehousing environment 110 may be provided with an IR LED badge holder reel device, where the geometrical configuration, the blinking frequency and the color of respective LEDs may be determined based on their group/department in the warehousing environment 110. For example, the maintenance personnel may have the reel device in which the LEDs are arranged in a line, and the operators may have the reel device in which the LEDs are arranged as square. In another example, the external personnel could have the reel device in which the LEDs are colored in red, whereas the others in blue. Thus, all the personnel of the warehousing environment 110 may be categorized into various IR LED groups, where each IR LED group may include a group of users whose badge holder reel devices either have a common geometrical configuration, a common blinking frequency, or a common color of respective LEDs. Each IR LED group corresponds to a unique combination of geometrical configuration, color, and the blinking frequency of LEDs of respective badge holder device.

Referring back to FIG. 1B, the user identification unit 106 includes a processor 122, an operation panel 124, and a memory 126 for identifying a type of each user in the warehousing environment 110 based on the input data received from the first and second cameras 104a and 104b. The processor 122 may include a computer, microcontroller, or other circuitry that controls the operations of various components such as the operation panel 124, and the memory 126. Optionally, the processor 122 includes, but is not limited to, a microprocessor, a microcontroller, a complex instruction set computing (CISC) microprocessor, a reduced instruction set (RISC) microprocessor, a very long instruction word (VLIW) microprocessor, or any other type of processing circuit. The processor 122 may execute software, firmware, and/or other instructions, for example, that are stored on a volatile or non-volatile memory, such as the memory 126, or otherwise provided to the processor 122. Then memory 126 may be a non-transitory computer readable medium. The processor 122 may be connected to the operation panel 124, and the memory 126, through wired or wireless connections, such as one or more system buses, cables, or other interfaces.

The operation panel 124 may be a user interface and may take the form of a physical keypad or touchscreen. The operation panel 124 may receive inputs from one or more users relating to selected functions, preferences, and/or authentication, and may provide and/or receive inputs visually and/or audibly. The memory 124, in addition to storing instructions and/or data for use by the processor 122, may also include user information associated with one or more users of the warehousing environment 110. For example, the user information may include authentication information (e.g. username/password pairs), user preferences, and other user-specific information. The processor 122 may access this data to assist in providing control functions (e.g. transmitting and/or receiving one or more control signals) related to operation of the operation panel 124, and the memory 126.

In an embodiment of the present disclosure, the processor 122 may be capable of executing machine learning algorithms such as deep neural networks to identify type of users in the warehousing environment 110. The processor 122 may include an Artificial Intelligence (AI) platform that may be implemented locally at a local computing device, or at a remote processing server for identifying a type of each user in the warehousing environment 110 based on corresponding IR LED badge holder reel device. In the context of the present disclosure, the processor 122 includes a graphical processing unit (GPU) for processing video/image data captured by the first and second video cameras 104a and 104b.

In operation, each IR LED device, such as the first IR LED device 102a of the warehousing environment 110 may generate a signal of a predetermined blinking frequency. Each of the first and second cameras 104a and 104b capture the videos/images pertaining to the blinking of the IR LEDs of the first IR LED device 102a, and provide captured video/image data to the processor 122.

The processor 122 is configured to implement video processing, image processing, and/or machine learning algorithms on the image/video data to detect an IR LED group of the first IR LED device 102a. The processor 122 may use the blinking frequency, color and/or geometrical configuration of LEDs detected in each frame of the image/video data, to detect the corresponding IR LED group, and thus type of the user of the first IR LED device 102a. For example, if the processor 122 is pre-trained with the information that the retail store associates would wear IR LED devices in which the LEDs are in square configuration, then when the LEDs of the first IR LED device 102a are detected to be in square configuration, then the processor 122 may generate an output indicating that the user wearing the first IR LED device 102a is a retail store associate.

In another embodiment of the present disclosure, the processor 122 may be configured to perform video processing, image processing, and/or machine learning algorithms for identifying type of users in a single frame of video/image data, and perform precise localization of all users. The processor 122 may be further configured to provide the relative positions between various types of users, and infer a wide range of retail processes flows such as customers forming long queues, too many employees in a certain zone, no maintenance person being detected at a location where an accident has been reported, congestion on the shelves, and the like.

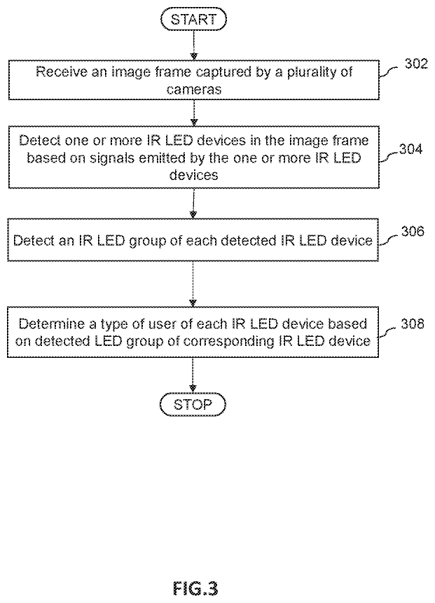

FIG. 3 is a flowchart illustrating a method for identifying a type of user in a warehousing environment, in accordance with an embodiment of the present disclosure.

At step 302, an image frame captured by a plurality of cameras is received. In an embodiment of the present disclosure, the plurality of cameras are installed in the warehousing environment to capture one or more images pertaining to the IR LED devices of the warehousing environment.

At step 304, one or more IR LED devices in the image frame are detected based on signals emitted by the one or more IR LED devices. In an embodiment of the present disclosure, each IR LED device is installed in an IR LED badge holder reel device worn by corresponding user. Further, each IR LED device includes a battery powered electronic board controlled with a periodic step signal to enable the plurality of IR LEDs to emit signals at the predetermined blinking frequency, and an optical lens configured to scatter light emitted by the plurality of LEDs to increase a detection angle of the plurality of cameras.

At step 306, an IR LED group of each detected IR LED device is detected based on a geometric configuration, a blinking frequency, and a color of LEDs of corresponding IR LED device. In an embodiment of the present disclosure, the predetermined geometrical configuration is selected from one of: a line configuration, a square configuration, and a triangle configuration. Also, one or more LED groups are assigned to one or more departments of the warehousing environment respectively.

At step 308, a type of user of each IR LED device is determined based on detected LED group of corresponding IR LED device. In an embodiment of the present disclosure, video processing, image processing and machine learning algorithms are implemented to identify a type of a user in the warehousing environment. Further, one or more retail process flows may be determined based on the localization of the users, a retail process flow being one of: customers forming long queues, a number of employees in a single zone crossing a predetermined threshold, an unreported accident, and congestion on the shelves of the warehousing environment.

Modifications to embodiments of the present disclosure described in the foregoing are possible without departing from the scope of the present disclosure as defined by the accompanying claims. Expressions such as “including”, “comprising”, “incorporating”, “consisting of”, “have”, “is” used to describe and claim the present disclosure are intended to be construed in a non-exclusive manner, namely allowing for items, components or elements not explicitly described also to be present. Reference to the singular is also to be construed to relate to the plural.

1. A system for identifying a type of a user in a warehousing environment, comprising:
a plurality of Infra Red (IR) Light Emitting Diode (LED) devices provided to a corresponding plurality of users in the warehousing environment, wherein each IR LED device includes a plurality of LEDs arranged in a predetermined geographical configuration, and configured to emit signals at a predetermined blinking frequency;
a plurality of cameras installed in the warehousing environment to capture one or more images pertaining to the IR LED devices of the warehousing environment; and
a user identification unit, in communication with the plurality of cameras, and comprises:
a memory to store one or more instructions; and
a processor communicatively coupled to the memory, and configured to:
receive an image frame captured by the plurality of cameras;
detect one or more IR LED devices in the image frame based on signals emitted by the one or more IR LED devices;
detect an IR LED group of each detected IR LED device based on a geometric configuration, a blinking frequency, and a color of LEDs of corresponding IR LED device; and
determine a type of user of each IR LED device based on detected LED group of corresponding IR LED device.

2. The system of claim 1, wherein each IR LED device is installed in an IR LED badge holder reel device worn by corresponding user.

3. The system of claim 1, wherein each IR LED device includes a battery powered electronic board controlled with a periodic step signal to enable the plurality of IR LEDs to emit signals at the predetermined blinking frequency, and an optical lens configured to scatter light emitted by the plurality of LEDs to increase a detection angle of the plurality of cameras.

4. The system of claim 1, wherein the geometrical configuration is selected from one of: a line configuration, a square configuration, and a triangle configuration.

5. The system of claim 1, wherein one or more LED groups are assigned to one or more departments of the warehousing environment respectively.

6. The system of claim 1, wherein the processor is configured to implement video processing, image processing and machine learning algorithms to identify a type of a user in the warehousing environment.

7. The system of claim 1, wherein the processor is configured to perform localization of the users of the warehousing environment based on the detected IR LED groups of corresponding IR LED devices.

8. The system of claim 7, wherein the processor is configured to determine one or more retail process flows based on the localization of the users, a retail process flow being one of:
customers forming long queues, a number of employees in a single zone crossing a predetermined threshold, an unreported accident, and congestion on the shelves of the warehousing environment.

9. A method for identifying a type of a user in a warehousing environment, in that each user is provided with an Infra Red (IR) Light Emitting Diode (LED) device, the method comprising:
receiving an image frame captured by a plurality of cameras;
detecting one or more IR LED devices in the image frame based on signals emitted by the one or more IR LED devices;
detecting an IR LED group of each detected IR LED device based on a geometric configuration, a blinking frequency, and a color of LEDs of corresponding IR LED device; and
determining a type of user of each IR LED device based on detected LED group of corresponding IR LED device.

10. The method of claim 9, wherein each IR LED device is installed in an IR LED badge holder reel device worn by corresponding user.

11. The method of claim 9, wherein each IR LED device includes a battery powered electronic board controlled with a periodic step signal to enable the plurality of IR LEDs to emit signals at the predetermined blinking frequency, and an optical lens configured to scatter light emitted by the plurality of LEDs to increase a detection angle of the plurality of cameras.

12. The method of claim 9, wherein the geometrical configuration is selected from one of: a line configuration, a square configuration, and a triangle configuration.

13. The method of claim 9, wherein one or more LED groups are assigned to one or more departments of the warehousing environment respectively.

14. The method of claim 9 further comprising implementing video processing, image processing and machine learning algorithms to identify a type of a user in the warehousing environment.

15. The method of claim 9 further comprising performing localization of the users of the warehousing environment based on the detected IR LED groups of corresponding IR LED devices.

16. The method of claim 15 further comprising determining one or more retail process flows based on the localization of the users, a retail process flow being one of: customers forming long queues, a number of employees in a single zone crossing a predetermined threshold, an unreported accident, and congestion on the shelves of the warehousing environment.

17. A non-transitory computer readable medium for identifying a type of user in a warehousing environment, the non-transitory computer readable medium comprising a set of instructions, the set of instructions when executed by a processor causes the processor to:
receive an image frame captured by a plurality of cameras;
detect one or more IR LED devices in the image frame based on signals emitted by the one or more IR LED devices;
detect an IR LED group of each detected IR LED device based on a geometric configuration, a blinking frequency, and a color of LEDs of corresponding IR LED device; and
determine a type of user of each IR LED device based on detected LED group of corresponding IR LED device.

18. The non-transitory computer readable medium of claim 17, wherein the set of instructions are configured to implement video processing, image processing and machine learning algorithms to identify a type of a user in the warehousing environment.

19. The non-transitory computer readable medium of claim 17, wherein the set of instructions are further configured to perform localization of the users of the warehousing environment based on the detected IR LED groups of corresponding IR LED devices.

20. The non-transitory computer readable medium of claim 19, wherein the set of instructions are further configured to determine one or more retail process flows based on the localization of the users, a retail process flow being one of: customers forming long queues, a number of employees in a single zone crossing a predetermined threshold, an unreported accident, and congestion on the shelves of the warehousing environment.
